(19) United States
(12) Patent Application Publication
(10) Pub. No.: US 2025/0071186 A1
(43) Pub. Date: Feb. 27, 2025

(54) Random Address Data Matching

(71) Applicant: The Nielsen Company (US), LLC, New York, NY (US)

(72) Inventors: Holly McCoy, Gainesville, FL (US); Oscar Blanco, Miami, FL (US); Meryem Berrada, Tampa, FL (US); Ronny Lerch, Oldsmar, FL (US)

(21) Appl. No.: 18/800,643

(22) Filed: Aug. 12, 2024

Related U.S. Application Data
(60) Provisional application No. 63/520,763, filed on Aug. 21, 2023.

(51) Int. Cl. H04L 67/50; H04L 43/0876

(52) U.S. Cl. CPC H04L 67/535; H04L 43/0876

(57) ABSTRACT

In one example, a method is described. The method includes: obtaining a non-persistent device identifier; obtaining network traffic data specifying, for each of multiple network devices, a network device identifier, one or more network device parameters, and a network time stamp; comparing user device parameters to network device parameters; selecting, based on the parameter comparison, one or more candidate device identifiers; comparing, for each candidate device identifier, the user device time stamp with the network time stamp associated with the candidate device identifier; selecting, based on the time stamp comparison, a target device identifier from the one or more candidate device identifiers; and updating the non-persistent device identifier associated with the user-associated device at a media exposure measurement location using the target device identifier selected from the one or more candidate device identifiers included in the network traffic data.

### CROSS-REFERENCE TO RELATED APPLICATIONS

This patent claims the benefit of U.S. Provisional Patent Application No. 63/520,763, which was filed on Aug. 21, 2023. U.S. Provisional Patent Application No. 63/520,763 is incorporated herein by reference in its entirety. Priority to U.S. Provisional Patent Application No. 63/520,763 is claimed.

### FIELD OF THE DISCLOSURE

This disclosure relates generally to media monitoring and, more particularly, to methods, systems, and articles of manufacture for using network traffic data to identify a new device identifier in lieu of an obsolete device identifier for the same device associated with media exposure at a media exposure measurement location.

### Usage and Terminology

In this disclosure, unless otherwise specified and/or unless the particular context clearly dictates otherwise, the terms “a” or “an” mean at least one, and the term “the” means the at least one.

As used herein, the terms “approximately,” “substantially,” and “about” modify their subjects/values to recognize the potential presence of variations that occur in real world applications. For example, “approximately,” “substantially,” and “about” can modify dimensions that may not be exact due to manufacturing tolerances or other real-world imperfections, as will be understood by persons of ordinary skill in the art. For example, “approximately,” “substantially,” and “about” can indicate that such dimensions are within a tolerance range of +/−10%, unless otherwise specified in the below description.

Unless specifically stated otherwise, descriptors such as “first,” “second,” “third,” etc., are used herein without imputing or otherwise indicating any meaning of priority, physical order, arrangement in a list, and ordering in any way, but are merely used as labels or arbitrary names to distinguish elements for ease of understanding the disclosed examples. In some examples, the descriptor “first” can refer to an element in the detailed description, while the same element can be referred to in a claim with a different descriptor such as “second” or “third.” In such instances, it should be understood that such descriptors are used merely for identifying those elements distinctly that might, for example, otherwise share the same name.

As used herein, the phrase “communicatively coupled,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, the term “engine” or “module” can broadly refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

### SUMMARY

This specification generally describes systems and methods that can identify a new device identifier for a device communicatively coupled to a network at a media exposure measurement location when the device may no longer be associated with its previous (i.e., obsolete) device identifier in the network traffic data. For example, the device identifier can be a non-persistent device identifier, i.e., a device identifier that can become obsolete for a variety of different reasons, such as each time the device connects to a network, periodically as a function of an operating system setting of the device, or due to any other causes.

As a particular example, the non-persistent device identifier can be a Media Access Control (MAC) address, which can be represented as a 48-bit identifier represented in hexadecimal format (e.g., 00:1A:2B:3C:4D:5E), an Open Device Identification (ODID) address, which can be represented as an alphanumeric string, or any other type of device identifier. Once a device identifier becomes obsolete, the association between the device identifier in the network traffic data and the device at the media exposure measurement location is lost. In other words, it may no longer be possible to track the network activity of the device at the media exposure measurement location using the network traffic data, which poses significant challenges for audience measurement.

The systems and methods described in this specification overcome these challenges by analyzing network traffic data to identify which of the device identifiers in the network traffic data correspond to a new device identifier for the device. In particular, the systems and methods described in this specification analyze network device parameters specified in network traffic data in order to select one or more candidate device identifiers that may correspond to the device at the media exposure measurement location. The systems and methods described in this specification select, from the candidate device identifiers and based on a time stamp comparison, a new device identifier for the device. In this manner, the systems and methods described in this specification can update the obsolete device identifier to the new device identifier, facilitating continuous network activity tracking for the device. Further, the systems and methods described in this specification can aggregate different device identifiers in the network traffic data that have all been used by the same device at different time points. This aggregate data can then be used for a variety of different purposes, for example, for crediting past media exposure.

In a first aspect, a method for updating a non-persistent device identifier associated with a user-associated device at a media exposure measurement location is described. The method includes: obtaining the non-persistent device identifier, the non-persistent device identifier having one or more user device parameters and a user device time stamp that characterize an activity of the user-associated device on a network at the media exposure measurement location. The method further includes: obtaining network traffic data via the network, the network traffic data specifying, for each of multiple network devices communicatively coupled to the network, a network device identifier associated with the network device, one or more network device parameters associated with the network device, and a network time stamp associated with a timing of at least one communication over the network by the network device.

The method further includes: comparing the one or more user device parameters to the one or more network device parameters associated with the plurality of network devices included in the network traffic data. The method further includes: selecting, based on the parameter comparison, one or more candidate device identifiers from the network device identifiers associated with the plurality of network devices included in the network traffic data. The method further includes: comparing, for each candidate device identifier, the user device time stamp with the network time stamp associated with the candidate device identifier.

The method further includes: selecting, based on the time stamp comparison, a target device identifier from the one or more candidate device identifiers. The method further includes: updating the non-persistent device identifier associated with the user-associated device at the media exposure measurement location using the target device identifier selected from the one or more candidate device identifiers included in the network traffic data.

In a second aspect, there is provided a computing system that includes: a processor, and a non-transitory computer-readable storage medium, having stored thereon machine-readable instructions that, upon execution by the processor, cause performance of operations of any preceding aspect.

In a third aspect, there is provided a non-transitory computer-readable storage medium, having stored thereon machine-readable instructions that, upon execution by a processor, cause performance of operations of any preceding aspect.

### BRIEF DESCRIPTION OF THE DRAWINGS

FIG. 1A and FIG. 1B are illustrations of an example device identifier tracking system in which various described operations can be implemented.

FIG. 2 is an illustration of example data processed by a device identifier tracking system to update a non-persistent device identifier.

FIG. 3 is a flow chart of an example method.

FIG. 4 is a simplified block diagram of an example computing device.

### DETAILED DESCRIPTION

### I. Overview

Audience Measurement Entities (AMEs) are entities that collect data about media consumption by consumers, referred to herein as “media exposure data,” for various purposes. Generally, media exposure data can characterize who is consuming media and what type of media is being consumed. In one example, media exposure data can include data that identifies media (e.g., metadata, codes, signatures, watermarks, etc.), data that identifies consumers (demographic information/data, usernames, etc.) and, in some cases, data that identifies how the media was presented to the consumer (e.g., an identifier of an application, time/duration of use of the application, etc.). Media exposure data collected by AMEs can be used by other entities such as advertisers to improve the effectiveness of their advertising campaigns, and publishers to gain a deeper insight into channel viewership.

Throughout this specification, the term “media” can refer to any type of content item (e.g., television programs, videos, movies, websites, etc.) delivered to a consumer via any distribution channel (e.g., television, radio, publishing/streaming via the Internet). The term “digital media” can refer to a subset of media that includes those content items that are accessible via the Internet. For example, digital media can be streamed via the Internet to devices such as desktop and laptop computers, tablets, mobile phones, and Connected televisions (CTVs).

AMEs can collect media exposure data for digital media by using a streaming meter. Throughout this specification, a “streaming meter” can refer to a device that can be communicatively coupled to a network at a consumer household and can monitor network traffic to collect network traffic data. The streaming meter can be in the form of a separate unit (e.g., separate from a modem, a router, or any other network access device at the consumer household), can be installed at any location in the consumer household, and can be coupled to any other device at the household through a wired, or wireless, connection. For example, the streaming meter can be coupled to an Internet access point (e.g., a router) and can monitor network traffic passing through the access point. Alternatively, the streaming meter can function as the modem and/or router for the consumer household.

Generally, “network traffic data” can include a variety of different network device (or user device) parameters characterizing an activity associated with a network device (or a user device) connected to a network, device identifiers associated with devices coupled to the network (which can include non-persistent device identifiers), and network timestamps characterizing a time of at least one communication over the network by the network device (or the user device). The network parameters can include, for example, inherent device attributes such as device models (e.g., “Galaxy S6,” “iPhone® 11 Pro,” etc.), operating system types (e.g., “Android®,” “iOS,” etc.), makes (e.g., “Samsung®,” “Apple®,” “Huawei®,” etc.), and device types (e.g., a tablet, a mobile phone, etc.), and acquired device attributes such as device labels (e.g., “Justin's iPhone®”). In some cases, the network parameters can further include, for example, URLs, domain names, user agents, Multipurpose Internet Mail Extension (MIME) types, bandwidth, and any other types of network parameters.

AMEs enroll consumers who consent to being monitored into a registered consumer panel. Then, AMEs or the registered panelists can install various media monitoring and media tracking equipment, including streaming meters and site meters, in registered panelist's households. As part of the enrollment process, AMEs can collect various types of information directly from the consumers about their household, such as types of devices used by the consumers to access media at the household, demographic information/data about the consumers (e.g., age, gender, etc.), and any other types of information. This information obtained directly from the consumers can form a part of the media exposure data collected by the AMEs, as described above.

In some cases, AMEs can associate data collected directly from consumers (e.g., collected during consumer enrollment into the panel), with one or more device identifiers collected by the streaming meter by monitoring network traffic data at the residential household. As a particular example, AMEs can associate a device identifier (e.g., a MAC address) of a device having streaming capabilities (e.g., a mobile device) with information about the consumer who owns the mobile device, or a particular media exposure site in the residential household. In this manner, the AMEs can generate the media exposure data that provides a mapping between the media being consumed by means of the streaming device at the media exposure site and the demographic information/data of consumers who are exposed to media by means of the streaming device.

However, as described above, in some cases the device identifier can be a non-persistent device identifier, such as a device identifier that can become obsolete for a variety of different reasons such as, for example, each time the device connects to a network, the device not connecting to the network for a prolonged period of time, the device going through a factory reset, periodically as a function of an operating system setting of the device, or as a result of any other type of action. Throughout this specification, a non-persistent device identifier becoming “obsolete” can refer to the non-persistent device identifier in the network traffic data being replaced by a second, different, device identifier in the network traffic data for the same device. “Different” device identifier can refer to a device identifier having one digit difference, two-digit difference, five-digit difference, or all-digits difference. In some cases, “different” device identifier can refer to a device identifier having a different format.

In some cases, the non-persistent device identifier (e.g., a MAC address) can become obsolete due to the process of MAC address randomization, which is a privacy feature of many modern operating systems. For example, instead of using the device's “true” or persistent MAC address, the operating system generates a temporary (e.g., non-persistent) and random MAC address for use by the device when connecting to the network. In some cases, the random MAC address may change periodically even when the device stays connected to the same network. Each time the non-persistent device identifier becomes obsolete, the association between the network activity of the device and other information about the device (e.g., its owner) is lost.

Accordingly, traditional audience measurement techniques often rely on the persistent nature of MAC addresses to identify and track devices over time. With MAC address randomization, the same device appears as multiple different devices over time, leading to fragmented and inaccurate data. Randomized MAC addresses disrupt the ability to link behaviors and viewership data across different sessions and devices and make it difficult to consistently recognize and track devices, resulting in potential double-counting or undercounting of viewers. Furthermore, MAC address randomization leads to inaccuracies in calculating unique viewership numbers and content reach metrics and hinders the ability to accurately target advertisements and assess advertisement campaign performance, which affects advertisement revenue and user experience. Because existing audience measurement tools are often designed to work with fixed MAC addresses, adapting these systems to handle randomized MAC addresses poses significant challenges and demands new technological solutions for audience measurement.

The systems and methods described in this specification overcome these challenges by using a streaming meter to obtain network traffic data, analyzing the network traffic data, automatically updating non-persistent device identifiers to device identifiers that are currently being used by the device to represent its identity and storing the device identifiers in an audience measurement database. The systems and methods described in this specification can use the streaming meter to automatically and continually (e.g., in real-time) monitor network traffic data for new device identifiers that are being used by the device, and continually updating the audience measurement database. Moreover, the systems and methods described in this specification can consolidate historical device identifier data for the device, which can be used for past media crediting purposes and for improving the overall accuracy of media exposure data.

Furthermore, the systems and methods described in this specification can automatically generate and transmit a message whenever the non-persistent device identifier is updated to the a device identifier, which can be presented on a user interface. By automatically updating non-persistent device identifiers, the systems and methods described in this specification can provide device mappings onto media consumption information with greater accuracy and using fewer computational resources (e.g., memory and computing power) than other systems.

### II. Device Identifier Tracking System Architecture

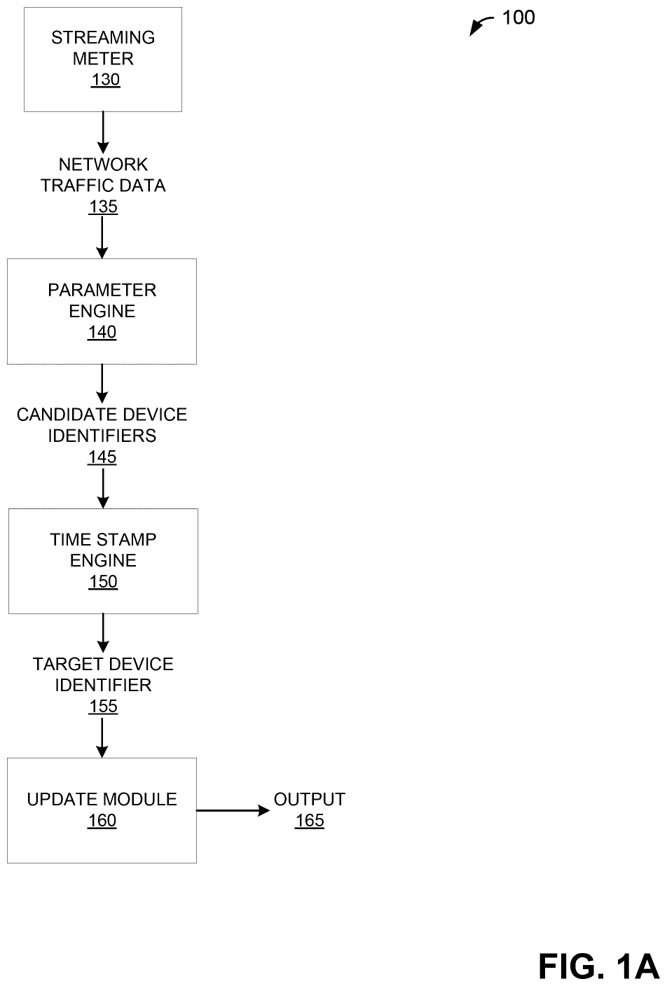

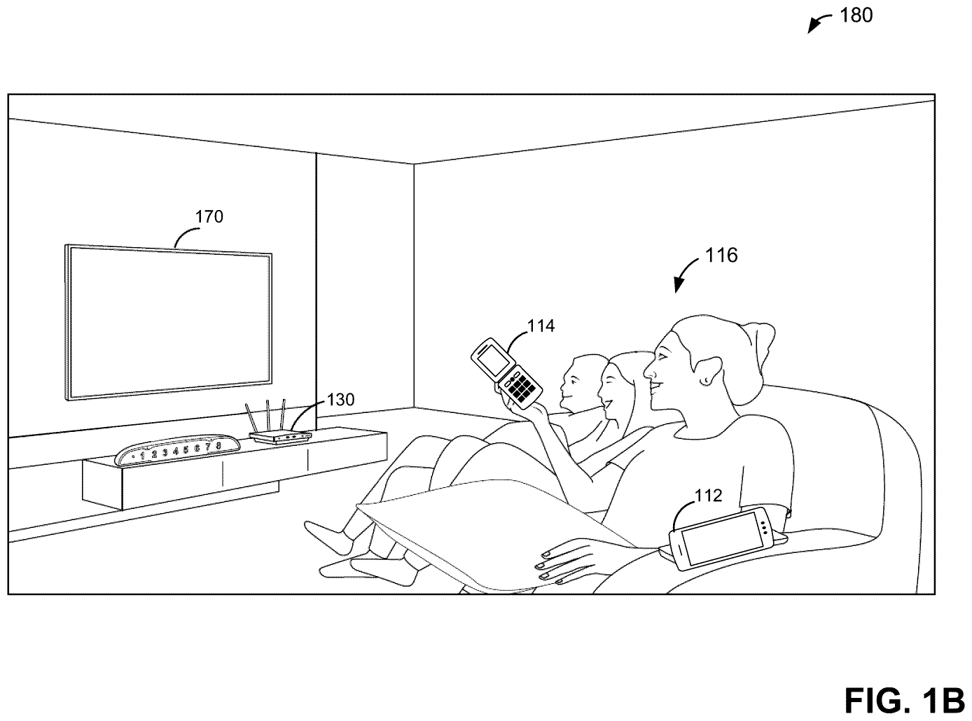

FIG. 1A and FIG. 1B illustrate an example device identifier tracking system 100 in which various described operations can be implemented. As illustrated in FIG. 1B, the device identifier tracking system 100 can include a media exposure measurement location 180, for example, a residential household of consumers 116 who are registered panelists with an AME, or any other type of location where consumers 116 are exposed to media.

Generally, the media exposure measurement location 180 can include any number of network devices, for example, a television 170, a mobile phone 114, a tablet 112, a computer (not shown), a speaker (not shown), or any other type of network device. The network devices can be connected to a network at the media exposure measurement location 180, such as a local area network (LAN), a wide area network (WAN) (e.g., the Internet), or any other type of network. The network devices can be configured to present media to the consumers 116 at the media exposure measurement locations 180 by, for example, streaming media content to the network devices via the network. As a particular example, as illustrated in FIG. 1B, the consumers 116 can stream media content to the television 170 via a streaming network device (e.g., a Roku® device). As another particular example, the consumers 116 can stream media content to the mobile phone 114 and/or the tablet 112 via the network.

As illustrated in FIG. 1B, the media exposure measurement location 180 can include a streaming meter 130, which is communicatively coupled to the network at the media exposure measurement location 180 and is configured to monitor network traffic to collect the network traffic data 135. For example, the streaming meter 130 can be coupled to an Internet access point (e.g., a router, not shown) and can monitor network traffic passing through the access point. In some instances, the streaming meter 130 is located in another room, such as another room of the media exposure measurement location 180 where the router is located. Generally, the streaming meter 130 can be coupled to the network and configured to monitor network traffic to collect network traffic data 135 in any appropriate manner.

The network traffic data 135 collected by the streaming meter 130 can include a device identifier (which can be a non-persistent device identifier or any other type of device identifier) for each network device at the media exposure measurement location 180. Some network devices can have a non-persistent device identifier that can at least partially depend on an internal assembly of the device. For example, some network devices can include multiple separate wireless network interface cards (NICs), each card configured to interface with a low or a high frequency band (e.g., 2.4 GHz or 5 GHz) when connecting to the network. In such cases, the network device may be able to support two device identifiers, one for each NIC/frequency band. Whenever the network device is connected to the network, it can switch between the frequency bands and therefore switch between the non-persistent device identifiers for that reason. The systems and methods described in this specification are equally applicable to devices having the aforementioned capabilities, as to devices having a single NIC card that supports multiple frequency bands and a single device identifier.

The network traffic data 135 can further include, for each network device connected to the network at the media exposure measurement location 180, one or more network device parameters associated with the network device. In some cases, the network device parameters can include a data element (e.g., a flag) indicating which frequency band the device identifier belongs to, such as the 2.4 GHz frequency band or the 5 GHz frequency band. As described above, the network device parameters can include inherent device attributes (e.g., type, make, model) and acquired device attributes (e.g., device labels). The acquired device attributes can be set by owners of the devices (e.g., the consumers 116) or determined in any other appropriate manner. In some cases, the network traffic data 135 collected by the streaming meter 130 can include a network time stamp that characterizes a time of at least one network communication by a network device at the media exposure measurement location 180. Throughout this specification, a “network communication” can refer to an instance of unidirectional or bidirectional transmission of a fundamental unit of information (e.g., a data packet) via the network. The network time stamp can define, for example, a time of a particular event associated with the data packet, such as the packet's creation, transmission, receipt, processing, or any other type of event. In some cases, the network traffic data 135 collected by the streaming meter 130 can include multiple network time stamps associated with the same network device identifier, each network time stamp characterizing a time of a particular event of the network device, as described above.

As described above, the device identifier tracking system 100 processes the network traffic data 135 to identify a new device identifier in lieu of a non-persistent (e.g., obsolete) device identifier for a device at the media exposure measurement location 180 and updates the non-persistent device identifier with the new device identifier. The device identifier tracking system 100 can update the non-persistent device identifier by using: (i) a parameter engine 140, (ii) a time stamp engine 150, and (iii) an update module 160.

In some cases, the device identifier tracking system 100 can include a server implemented by one or more computers located in one or more locations, the server including the parameter engine 140, the time stamp engine 150, and the update module 160. For example, the server can be located remotely from the media exposure measurement location 180, and can be operated by the AME. The server can be communicatively coupled to the streaming meter 130 and can be configured to receive the network traffic data 135 from the streaming meter 130. The server can communicate with the streaming meter 130 in any appropriate manner, for example, through Internet messages (e.g., a HyperText Transfer Protocol (HTTP) request(s)) that include data obtained by the streaming meter 130. Other example modes of communication between the server and the streaming meter 130 can include an HTTP Secure protocol (HTTPS), a file transfer protocol (FTP), a secure file transfer protocol (SFTP), or any other mode of communication.

The functions of the parameter engine 140, the time stamp engine 150, and the update module 160 are described in more detail next.

The parameter engine 140 is configured to obtain the network traffic data 135 from the streaming meter 130 via the network. As described above, the network traffic data 135 can specify, for each network device (e.g., the television 170, the mobile phone 114, the tablet 112, etc.) communicatively coupled to the network at the media exposure measurement location 180, a network device identifier, one or more network device parameters, and a network time stamp that characterizes a time of at least one communication over the network by the network device.

In some cases, the device identifier tracking system 100 can obtain a non-persistent device identifier associated with a user device at the media exposure measurement location 180, one or more user device parameters and a user device time stamp that characterize the network activity of the user device at the media exposure measurement location 180. For convenience, throughout this specification, a “user device” can refer to a device connected to the network at the media exposure measurement location 180 for which the device identifier tracking system 100 updates the non-persistent device identifier. A “network device” can refer to any device connected to the network at the media exposure measurement location 180. In other words, the term “user device” can refer to a single network device included in a set of network devices connected to the network at the media exposure measurement location 180. The device identifier tracking system 100 can obtain the non-persistent device identifier, the one or more user device parameters, and the user device time stamp in any appropriate manner, for example, the system 100 can obtain them by using the streaming meter 130 and/or based on the information provided by the consumers 116 during enrollment into the AME panel.

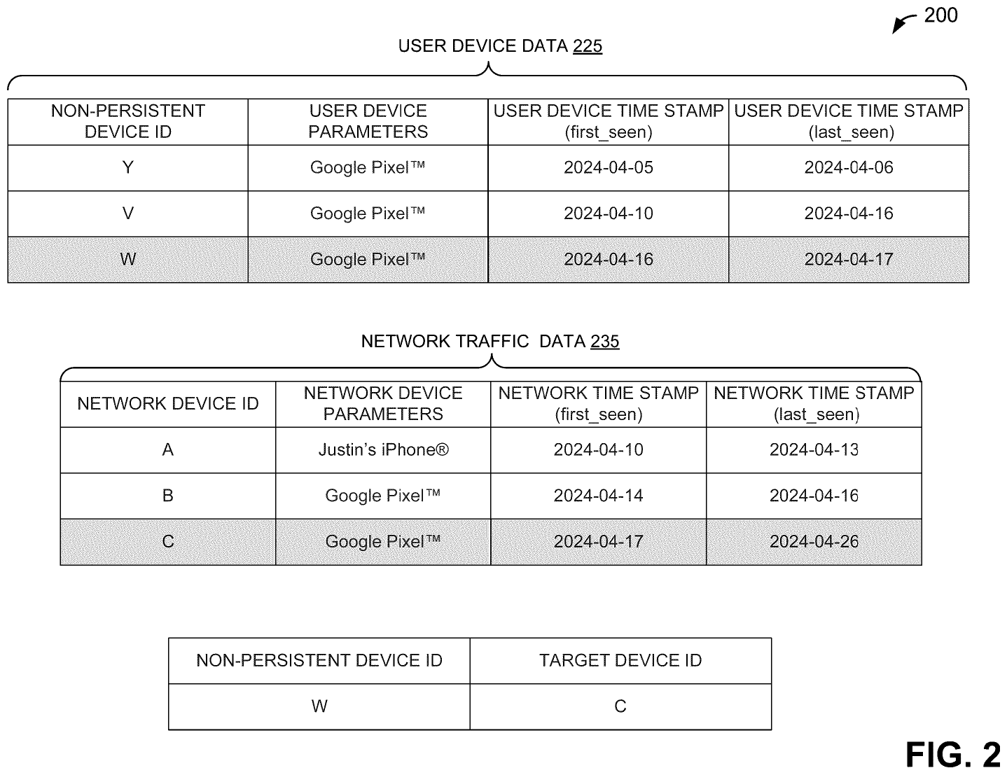

The parameter engine 140 can be configured to process the network traffic data 135 to select one or more candidate device identifiers 145 from the device identifiers included in the network traffic data 135. For example, the parameter engine 140 can be configured to compare one or more user device parameters of the user device (for which the device identifier tracking system 100 updates the non-persistent device identifier) to the one or more network device parameters included in the network traffic data 135. As a particular example, the parameter engine 140 can compare one or more inherent device attributes (e.g., type, make, model) of the user device with one or more inherent device attributes of a network device as specified in the network traffic data 135. As another particular example, the parameter engine 140 can compare one or more acquired device attributes (e.g., device labels) of the user device with one or more acquired device attributes of the network device as specified in the network traffic data 135. This process is described in more detail with reference to FIG. 2.

Based on the parameter comparison, the parameter engine 140 can select one or more candidate device identifiers 145 from the device identifiers included in the network traffic data 135. For example, the parameter engine 140 can select one or more candidate device identifiers 145 by selecting those device identifiers included in the network traffic data 135 that have at least one inherent or acquired attribute that substantially matches the inherent or acquired attribute of the user device, respectively. In this manner, the parameter engine 140 can use the parameters specified by the network traffic data 135 to select those device identifiers in the network traffic data 135 that have a higher likelihood of belonging to the user device than the other device identifiers specified by the network traffic data 135. The process performed by the parameter engine 140 is described in more detail below with reference to FIG. 2.

The parameter engine 140 can provide the one or more candidate device identifiers 145 to the time stamp engine 150. The time stamp engine 150 is configured to process the one or more candidate device identifiers 145 to select a target device identifier 155 from the one or more candidate device identifiers 145. For example, the time stamp engine 150 can compare, for each candidate device identifier, the user device time stamp with the network time stamp associated with the candidate device identifier. The time stamp engine 150 can select, based on the time stamp comparison, the target device identifier 155 from the one or more candidate device identifiers 145.

As a particular example, the time stamp engine 150 can identify which network time stamp indicates a substantially later time (e.g., 1 second later, 1 minute later, 1 hour later, or any other amount of time later) than the user device time stamp. The time stamp engine 150 can select that candidate device identifier as the target device identifier 155 which has the network time stamp indicating a time that is later than the time indicated by the user device time stamp. The network device time stamp indicating a later time than the time indicated by the user device time stamp can mean that the target device identifier associated with the network time stamp appeared in the network traffic data 135 a threshold amount of time (also referred to as a time gap being above a threshold) after the non-persistent device identifier became obsolete, for example, disappeared from the network traffic data 135. This, in turn, can mean that the target device identifier can be a new identifier that is now being used by the user device to identify itself in the network traffic data 135. The process performed by the time stamp engine 150 is described in more detail below with reference to FIG. 2.

The time stamp engine 150 can provide the target device identifier 155 to the update module 160. The update module 160 can be configured to update the non-persistent device identifier of the user device by replacing the non-persistent device identifier with the target device identifier, for example, in the network traffic data 135 obtained from the streaming meter 135, in the database of the AME, or in any other location. In some cases, the update module 160 can be configured to process the target device identifier 155 to generate an output 165, where the output 165 can include the target device identifier 155 and any other information associated with the user device. In some cases, the device identifier tracking system 100 can identify multiple target device identifiers 155 for the user device. In other words, the device identifier tracking system 100 can determine that more than one device identifier in the network traffic data 135 has a substantially high likelihood that it is being used by the user device to identify itself in the network traffic data 135 instead of the obsolete non-persistent device identifier. In such cases, the update module 160 can generate the output 165 that includes, for example, a list, or a set, of the target device identifiers 155.

The server can output the target device identifier(s) 155 and any other information associated with the user device by presenting them on a user interface of an application programming interface (API) made available by the server. In another example, the server can output the target device identifier(s) 155 and any other information associated with the user device by transmitting them to a computing device, a computing system, another server, or any other computing environment, for presentation on a user interface. In yet another example, the server can output the target device identifier(s) 155 and any other information associated with the user device by storing them in a database included in the device identifier tracking system 100.

In some cases, the database can be an audience measurement database owned and managed by the AME. Generally, the audience measurement database can be located in any location, or multiple locations. In some cases, the audience measurement database can be included in the server of the device identifier tracking system 100 described above, or it can be located remotely from the server. The audience measurement database can store information associated with media consumption by consumers 116 at the media exposure measurement location 180. For example, the audience measurement database can store information provided directly by the consumers 116 during enrollment into the AME panel, such as device identifiers for network devices and inherent/acquired device attributes, as described above. As another example, the audience measurement database can store network traffic data 135 collected by the streaming meter 130. As a particular example, the audience measurement database can specify, for each device identifier, a corresponding set of one or more network device parameters, and one or more network time stamps.

The audience measurement database can additionally or alternatively store any other types of information. The audience measurement database can be implemented by any type of memory, storage device, and/or storage disc for storing data such as, for example, flash memory, magnetic media, optical media, solid state memory, hard drive(s), thumb drive(s), etc. Furthermore, the data stored in the audience measurement database may be in any data format such as, for example, binary data, comma delimited data, tab delimited data, structured query language (SQL) structures, or any other type of data.

In some implementations, the device identifier tracking system 100 can generate a message whenever the non-persistent device identifier is updated with the target device identifier 155. For example, the device identifier tracking system 100 can generate a message when the non-persistent device identifier is updated with the target device identifier 155 in the audience measurement database described above. The message can have any format and can be transmitted to a computing device, a computing system, another server, or any other computing environment, for presentation on a user interface. In some cases, the device identifier tracking system 100 can present the message on a user interface of an application programming interface (API) made available by the server.

In some implementations, the device identifier tracking system 100 can repeatedly perform the process described above. For example, after updating the non-persistent device identifier with the target device identifier 155, the device identifier tracking system 100 can detect when the updated non-persistent device identifier became obsolete (e.g., disappeared from the network traffic data 135) and, after a threshold amount of time, again perform the process described above to identify a new target device identifier for updating the non-persistent device identifier. At each time step of the repeated process, the device identifier tracking system 100 can store the target device identifier 155 determined for the time step in a database, for example, the audience measurement database described above. The device identifier tracking system 100 can aggregate the target device identifiers determined for multiple time steps and use the aggregated data to determine past, or historical, media exposure data that may otherwise be lacking due to unknown history of device identifiers for the user device.

Generally, the device identifier tracking system 100 can determine the media exposure data in any appropriate manner. For example, the device identifier tracking system 100 can associate a panelist profile with the user device based on the updated non-persistent device identifier of the user device. The panelist profile can include, for example, demographic information about the panelist (e.g., a user of the user device), a user identifier, a panelist identifier, a username, or any other type of information characterizing an identity of the panelist who is a user of the user device. The device identifier tracking system 100 can determine the panelist profile in any appropriate manner, for example, based on information provided by the consumers 116 during enrollment into the AME panel. In some cases, the panelist profile can be stored in the audience measurement database described above.

In some cases, the device identifier tracking system 100 can associate media-identifying information (e.g., metadata, codes, signatures, watermarks, etc.) and application usage information (e.g., an identifier of an application, a time or duration of use of the application, a rating of the application, etc.) with the panelist profile. In this manner, the device identifier tracking system 100 can generate the media exposure data that can be used for a variety of different purposes, such as by entities like advertisers to improve the effectiveness of their advertising campaigns, and publishers to gain a deeper insight into channel viewership.

By automatically updating the non-persistent device identifier of the user device as described above, the device identifier tracking system 100 can provide device mappings onto media consumption information with greater accuracy and using fewer computational resources (e.g., memory and computing power) than other systems. Moreover, AMEs can use the mappings to generate media exposure data with greater accuracy, thereby allowing broadcasters and advertisers to make effective advertising/media inventory optimization decisions.

FIG. 2 is an illustration of example data 200 processed by a device identifier tracking system (e.g., the device identifier tracking system 100 in FIG. 1A) to update a non-persistent device identifier of a user device.

FIG. 2 illustrates example user device data 225, which can be obtained by a streaming meter, such as the streaming meter 130 in FIG. 1A and FIG. 1B, over any duration of time, for example, 1 hour, 1 day, 2 days, 5 days, 1 week, 1 month, 1 year, or any other duration of time. Generally, the user device data 225 can be obtained in any appropriate manner. The user device data 225 can include the non-persistent device identifier (e.g., “Y,” “V,” “W”) of the user device and one or more user device parameters (e.g., “Google Pixel™”). The user device data 225 can further include one or more user device time stamps, for example, a “first_seen” time stamp and a “last_seen” time stamp. The “first_seen” time stamp can characterize a time when at least one communication associated with the user device was first detected on the network by the streaming meter. The “last_seen” time stamp can characterize a time when at least one communication associated with the user device was last detected on the network by the streaming meter. As described above, the user device/network time stamps can have any format, for example, can include a date and/or time up to any appropriate resolution, such as a second, a minute, an hour, a day, or any other time resolution.

As illustrated in FIG. 2, the user device used the non-persistent device identifier “Y” to identify itself on the network until the date indicated by the “last_seen” user device time stamp of “2024-04-06.” After that date, the non-persistent device identifier “Y” became obsolete and was replaced by the non-persistent device identifier “V” on the date indicated by the “first_seen” user device time stamp of “2024-04-10.” The non-persistent device identifier “V” was active until the date indicated by the “last_seen” user device time stamp of “2024-04-16,” and was replaced by the non-persistent device identifier “W” on the date indicated by the “first_seen” user device time stamp of “2024-04-16.” The device identifier tracking system can determine that the non-persistent device identifier “W” became obsolete, for example, disappeared from the network, on the date indicated by the “last_seen” user device time stamp of “2024-04-17.”

Accordingly, the device identifier tracking system can use the non-persistent device identifier “W” of the user device, the one or more user device parameters “Google Pixel™,” and the one or more user device time stamps “first_seen” “2024-04-16” and “last_seen” “2024-04-17” to identify a new (e.g., target) device identifier for the user device based on example network traffic data 235.

As described above, the network traffic data 235 can be obtained by a streaming meter, such as the streaming meter 130 in FIG. 1A and FIG. 1B, over any duration of time, for example, 1 hour, 1 day, 2 days, 5 days, 1 week, 1 month, 1 year, or any other duration of time. In some cases, the network traffic data 235 can represent data that was obtained after (e.g., at a later time) than the user device data 225. The network traffic data 235 can include, for each network device, a network device identifier, one or more network device parameters, and one or more network time stamps. For example, the network traffic data 235 can specify, for a first network device, a network device identifier “A,” one or more network device parameters “Justin's iPhone®,” a “first_seen” network time stamp indicating a date of “of “2024-04-10,” and a “last_seen” network time stamp indicating a date of “2024-04-13.”

As described above, the device identifier tracking system can compare one or more user device parameters specified by the user device data 225 with one or more network device parameters specified by the network traffic data 235. Based on the parameter comparison, the device identifier tracking system can select one or more candidate device identifiers from the network traffic data 235, for example, one or more device identifiers that the user device may be using instead of the non-persistent device identifier “W” to identify itself in the network traffic data 235. For example, the device identifier tracking system can compare the user device parameter “Google Pixel™” of the user device identified by “W” to “Justin's iPhone®” network device parameter of the network device identified by “A.” As another example, the device identifier tracking system can compare the user device parameter “Google Pixel™” of the user device identified by “W” to “Google Pixel™” network device parameter of the network device identified by “B.”

As a particular example, the device identifier tracking system can determine if at least 50%, at least 60%, at least 70%, at least 80%, at least 90%, or at least 99% of characters representing the user device parameter match the characters representing the network device parameter. If at least a particular percentage threshold of characters do not match, then the device identifier tracking system can determine that the user device parameter does not match the network device parameter. As a particular example, the device identifier tracking system can determine that the user device parameter “Google Pixel™” of “W” does not match at least 99% of characters of the network device parameter “Justin's iPhone®” of “A”. As another particular example, the device identifier tracking system can determine that the user device parameter “Google Pixel™” of “W” does match at least 99% of characters of the network device parameter “Google Pixel™” of “B” and “Google Pixel™” of “C” in the network traffic data 235. Accordingly, based on the parameter comparison, the device identifier tracking system can select the device identifier “B” and the device identifier “C” as candidate device identifiers from the network traffic data 235.

In some implementations, the user device and/or one or more network devices can have a device identifier that is associated with a high frequency band (e.g., 5 GHz) or a low frequency band (e.g., 2.4 GHz). The user device data 225 and/or the network traffic data 235 can accordingly include a data element (e.g., a flag) indicating which frequency band the device identifier is associated with, for example, an “L” for the low frequency band and an “H” for the high frequency band. In such cases, the device identifier tracking system can determine if the non-persistent device identifier “W” of the user device is associated with the high frequency band or the low frequency band, based on the flag included in the user device data 225. Based on the determination, the device identifier tracking system can select the one or more candidate device identifiers that are associated with the same frequency band as the non-persistent device identifier by, for example, comparing the flag associated with the non-persistent device identifier “W” with each of the flags associated with the network device identifier “B” and network device identifier “C” in the network traffic data 235.

As described above, the device identifier tracking system can compare, for each candidate device identifier, the user device time stamp in the user device data 225 with the network time stamp associated with the candidate device identifier in the network traffic data 235. Based on the time stamp comparison, the device identifier tracking system can select a target device identifier from the candidate device identifiers in the network traffic data 235, such as a device identifier having the highest likelihood (compared to other candidate device identifiers) of being used by the user device to identify itself in the network traffic data 235 instead of the non-persistent device identifier “W.”

For example, the device identifier tracking system can compare the “first_seen” network time stamp of the network device identified by “B” in the network traffic data 235 to the “last_seen” user device time stamp of the user device identified by “W” in the user device data 225. In this example, the device identifier tracking system can determine that the “first_seen” network time stamp of “B” represents an earlier date (and/or time) than the “last_seen” user device time stamp of “W.” Accordingly, the device identifier tracking system can determine that the network device identified by “B” appeared on the network prior to the user device identified by “W” disappearing from the network which, in turn, can mean that the network device identified by “B” is a different device from the user device identified by “W.” In other words, the device identifier tracking system can determine that the device identifier “B” is not the target device identifier.

As another example, the device identifier tracking system can compare the “first_seen” network time stamp of the network device identified by “C” in the network traffic data 235 to the “last_seen” user device time stamp of the user device identified by “W” in the user device data 225. In this example, the device identifier tracking system can determine that the “first_seen” network time stamp of “C” represents a date (and/or time) that is substantially the same, or a threshold amount of time after, the date (and/or time) represented by the “last_seen” user device time stamp of “W.” The threshold amount of time can be any amount of time, such as 1 second, 1 minute, 30 minutes, 1 hour, 5 hours, 24 hours, or any other amount of time. Based on the time stamp comparison, the device identifier tracking system can determine that the network device identifier “C” is the target device identifier, for example, a device identifier that is being used by the user device to identify itself in the network traffic data 235 instead of the non-persistent device identifier “W.”

In some implementations, the device identifier tracking system can perform the time stamp comparison by generating a chronological sequence of candidate device identifiers based on their network time stamps. For example, the device identifier tracking system can compare the “first_seen” network time stamps between the candidate device identifiers (e.g., “B” and “C”) and arrange the candidate device identifiers such that their “first_seen” time stamps are arranged in a chronological order. As a particular example, as illustrated in the network traffic data 235, the device identifier tracking system can place the candidate device identifier (e.g., “B”) having the “first_seen” network time stamp (e.g., “2024-04-14”) indicating the earliest time (compared to the “first_seen” network time stamps of the other candidate device identifiers) in a first row. The device identifier tracking system can place the candidate device identifier (e.g., “C”) having the “first_seen” network time stamp (e.g., “2024-04-17”) indicating a later time than the earliest time in a row that is after the first row. The device identifier tracking system can perform this process for all candidate device identifiers identified based on the parameter comparison, as described above.

The device identifier tracking system can remove, from the chronological sequence, candidate device identifiers having the network time stamp that indicates a time that is before a time indicated by the user device time stamp. As described above, the “first_seen” network time stamp of “B” indicates an earlier time than the “last_seen” network time stamp of “W.” Accordingly, the device identifier tracking system can remove the device identifier “B” from the chronological sequence. After removing candidate device identifiers from the chronological sequence, the device identifier tracking system can select a first device identifier in the chronological sequence of the candidate device identifiers as the target device identifier. For example, the device identifier tracking system can select the device identifier “C” as the target device identifier.

The device identifier tracking system can update the non-persistent device identifier “W” with the target device identifier “C” by, for example, replacing “W” with “C” in the audience measurement database described above, or in any other appropriate manner. In some cases, the device identifier tracking system can update the user device data 225 in the audience measurement database by adding the target device identifier by, for example, adding a row for the target device identifier “C” and including the parameters and the time stamps associated with the target device identifier “C” from the network traffic data 235.

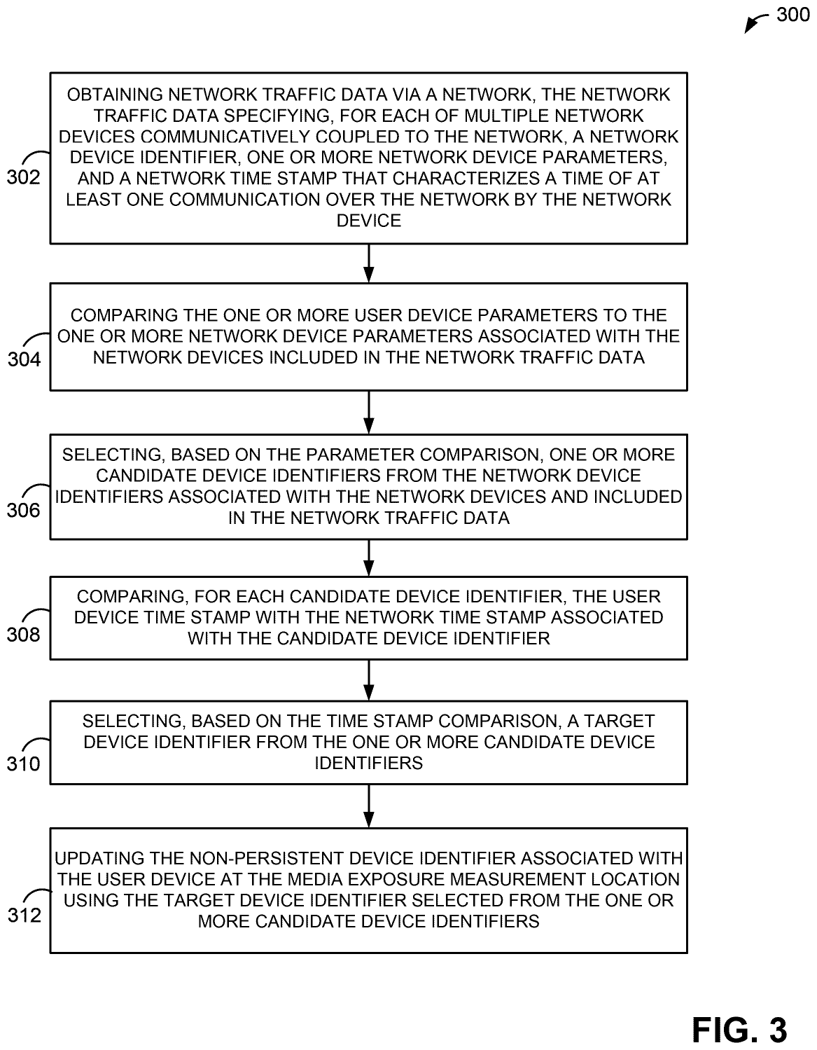

FIG. 3 is a flow chart of an example method 300. Method 300 can be carried out by a system of one or more computers located in one or more locations. For example, the device identifier tracking system 100 described above with reference to FIG. 1, programmed in accordance with the specification, can perform method 300.

At block 302, method 300 includes obtaining, via a network, network traffic data. The network traffic data can specify, for each of multiple network devices communicatively coupled to the network at a media exposure measurement location, a network device identifier associated with the network device, one or more network device parameters associated with the network device, and a network time stamp that characterizes a time of at least one communication over the network by the network device. In some cases, the device identifier of the user device and the device identifiers of the network devices include a Media Access Control (MAC) address. In some cases, the user device can be a mobile phone. In some cases, the one or more user device parameters and the one or more network device parameters include a device model and a device label.

The network traffic data can be collected by a streaming meter configured to monitor the network to collect the network traffic data, where the streaming meter is communicatively coupled to the network devices via the network.

At block 304, method 300 includes comparing the one or more user device parameters to the one or more network device parameters associated with the network devices and included in the network traffic data.

At block 306, method 300 includes selecting, based on the parameter comparison, one or more candidate device identifiers from the device identifiers associated with the network devices included in the network traffic data.

At block 308, method 300 includes comparing, for each candidate device identifier, the user device time stamp with the network time stamp associated with the candidate device identifier. In some cases, (i) the user device time stamp includes a last-seen time stamp that characterizes a time when the non-persistent device identifier associated with the user device was last detected on the network, and (ii) the network time stamp includes a first-seen time stamp that characterizes a time when the network device identifier associated with the network device was first detected on the network.

In some cases, comparing, for each candidate device identifier, the user device time stamp with the network time stamp associated with the candidate device identifier includes: generating a chronological sequence of candidate device identifiers based on the network time stamps, and removing, from the chronological sequence, candidate device identifiers having the network time stamp that indicates a time that is before a time indicated by the user device time stamp. After removing candidate device identifiers from the chronological sequence, the device identification tracking system can select a first device identifier in the chronological sequence as the target device identifier.

In some cases, comparing, for each candidate device identifier, the user device time stamp with the network time stamp associated with the candidate device identifier includes: determining if a time gap between the user device time stamp and the network time stamp is above a threshold.

At block 310, method 300 includes selecting, based on the time stamp comparison, a target device identifier from the one or more candidate device identifiers.

At block 312, method 300 includes updating the non-persistent device identifier associated with the user device at the media exposure measurement location using the target device identifier selected from the one or more candidate device identifiers included in the network traffic data. For example, updating the non-persistent device identifier can include: replacing the non-persistent device identifier associated with the user device at the media exposure measurement location with the target device identifier.

In some implementations, method 300 further includes based on updating the non-persistent device identifier associated with the user device using the target device identifier, determining media exposure data based at least on the network traffic data and the target device identifier, and associating the media exposure data with demographic data of a user associated with the user device represented by the target device identifier.

In some implementations, method 300 further includes outputting the target device identifier as a new device identifier for the user device at the media exposure measurement location.

In some implementations, method 300 further includes determining if the device identifier of the user device is associated with a high frequency band of the network or a low frequency band of the network, and based on the determination, selecting the one or more candidate device identifiers that are associated with the high frequency band of the network or the low frequency band of the network, respectively.

### III. Example Computing Device

Any one or more of the above-described components can take the form of a computing device, or a computing system that includes one or more computing devices.

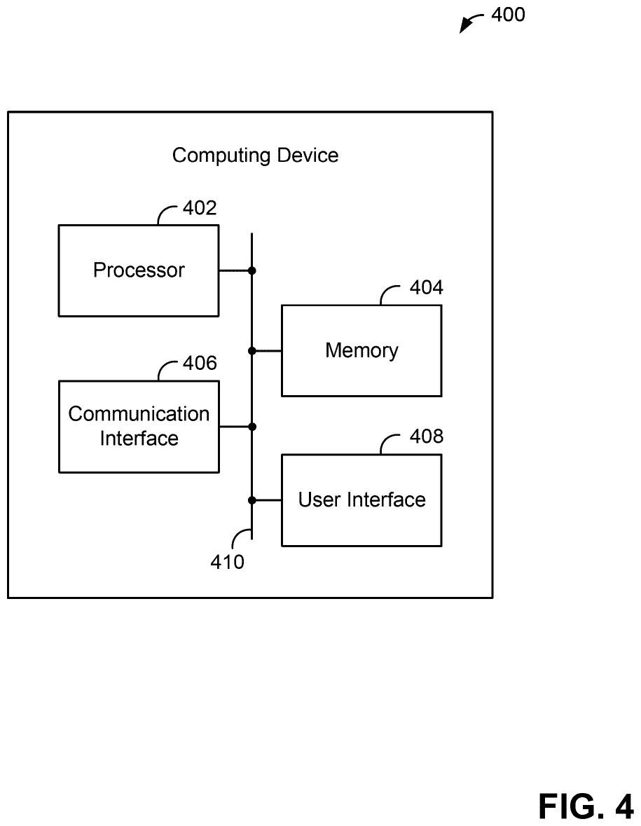

FIG. 4 is a simplified block diagram of an example computing device 400. The computing device 400 can be configured to perform one or more operations, such as the operations described in this disclosure. As shown, the computing device 400 can include various components, such as a processor 402, memory 404, a communication interface 406, and/or a user interface 408. These components can be connected to each other (or to another device, system, or other entity) via a connection mechanism 410.

The processor 402 can include one or more general-purpose processors and/or one or more special-purpose processors.

Memory 404 can include one or more volatile, non-volatile, removable, and/or non-removable storage components, such as magnetic, optical, or flash storage, and/or can be integrated in whole or in part with the processor 402. Further, memory 404 can take the form of a non-transitory computer-readable storage medium, having stored thereon computer-readable program instructions (e.g., compiled or non-compiled program logic and/or machine code) that, upon execution by the processor 402, cause the computing device 400 to perform one or more operations, such as those described in this disclosure. The program instructions can define and/or be part of a discrete software application. In some examples, the computing device 400 can execute the program instructions in response to receiving an input (e.g., via the communication interface 406 and/or the user interface 408). Memory 404 can also store other types of data, such as those types described in this disclosure. In some examples, memory 404 can be implemented using a single physical device, while in other examples, memory 404 can be implemented using two or more physical devices.

The communication interface 406 can include one or more wired interfaces (e.g., an Ethernet interface) or one or more wireless interfaces (e.g., a cellular interface, Wi-Fi interface, or Bluetooth® interface). Such interfaces allow the computing device 400 to connect with and/or communicate with another computing device over a computer network (e.g., a home Wi-Fi network, cloud network, or the Internet) and using one or more communication protocols. Any such connection can be a direct connection or an indirect connection, the latter being a connection that passes through and/or traverses one or more entities, such as a router, switcher, server, or other network device. Likewise, in this disclosure, a transmission of data from one computing device to another can be a direct transmission or an indirect transmission.

The user interface 408 can facilitate interaction between computing device 400 and a user of computing device 400, if applicable. As such, the user interface 408 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, the user interface 408 can include hardware and/or software components that facilitate interaction between the computing device 400 and the user of the computing device 400.

The connection mechanism 410 can be a cable, system bus, computer network connection, or other form of a wired or wireless connection between components of the computing device 400.

One or more of the components of the computing device 400 can be implemented using hardware (e.g., a digital signal processor (DSP), an application-specific integrated circuit (ASIC), a field-programmable gate array (FPGA), another programmable logic device, or discrete gate or transistor logic), software executed by one or more processors, firmware, or any combination thereof. Moreover, any two or more of the components of the computing device 400 can be combined into a single component, and the function described herein for a single component can be subdivided among multiple components.

### IV. Example Variations

Although the examples and features described above have been described in connection with specific entities and specific operations, in some scenarios, there can be many instances of these entities and many instances of these operations being performed, perhaps contemporaneously or simultaneously, on a large-scale basis.

In addition, although some of the operations described in this disclosure have been described as being performed by a particular entity, the operations can be performed by any entity, such as the other entities described in this disclosure. Further, although the operations have been recited in a particular order and/or in connection with example temporal language, the operations need not be performed in the order recited and need not be performed in accordance with any particular temporal restrictions. However, in some instances, it can be desired to perform one or more of the operations in the order recited, in another order, and/or in a manner where at least some of the operations are performed contemporaneously/simultaneously. Likewise, in some instances, it can be desired to perform one or more of the operations in accordance with one more or the recited temporal restrictions or with other timing restrictions. Further, each of the described operations can be performed responsive to performance of one or more of the other described operations. Also, not all of the operations need to be performed to achieve one or more of the benefits provided by the disclosure, and therefore not all of the operations are required.

Although certain variations have been described in connection with one or more examples of this disclosure, these variations can also be applied to some or all of the other examples of this disclosure as well and therefore aspects of this disclosure can be combined and/or arranged in many ways. The examples described in this disclosure were selected at least in part because they help explain the practical application of the various described features.

Also, although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method for updating a non-persistent device identifier associated with a user device at a media exposure measurement location, the user device having one or more user device parameters and a user device time stamp that characterize an activity of the user device on a network at the media exposure measurement location, the method comprising:
obtaining network traffic data via the network, the network traffic data specifying, for each of a plurality of network devices communicatively coupled to the network at the media exposure measurement location, a network device identifier associated with the network device, one or more network device parameters associated with the network device, and a network time stamp that characterizes a time of at least one communication over the network by the network device;
comparing the one or more user device parameters to the one or more network device parameters associated with the plurality of network devices and included in the network traffic data;
selecting, based on the parameter comparison, one or more candidate device identifiers from the device identifiers associated with the plurality of network devices included in the network traffic data;
comparing, for each candidate device identifier, the user device time stamp with the network time stamp associated with the candidate device identifier;
selecting, based on the time stamp comparison, a target device identifier from the one or more candidate device identifiers; and
updating the non-persistent device identifier associated with the user device at the media exposure measurement location using the target device identifier selected from the one or more candidate device identifiers included in the network traffic data.

2. The method of claim 1, further comprising:
based on updating the non-persistent device identifier associated with the user device using the target device identifier, determining media exposure data based at least on the network traffic data and the target device identifier; and
associating the media exposure data with demographic data of a user associated with the user device represented by the target device identifier.

3. The method of claim 1, wherein:
the user device time stamp comprises a last-seen time stamp that characterizes a time when the non-persistent device identifier associated with the user device was last detected on the network, and
the network time stamp comprises a first-seen time stamp that characterizes a time when the network device identifier associated with the network device was first detected on the network.

4. The method of claim 1, wherein updating the non-persistent device identifier associated with the user device using the target device identifier selected from the one or more candidate device identifiers comprises:
replacing the non-persistent device identifier associated with the user device at the media exposure measurement location with the target device identifier.

5. The method of claim 1, wherein the device identifier of the user device and the device identifiers of the plurality of network devices comprise a Media Access Control (MAC) address.

6. The method of claim 1, wherein the user device comprises a mobile phone.

7. The method of claim 1, wherein the network traffic data is collected by a streaming meter configured to monitor the network to collect the network traffic data, and wherein the streaming meter is communicatively coupled to the plurality of network devices via the network.

8. The method of claim 1, further comprising:
outputting the target device identifier as a new device identifier for the user device at the media exposure measurement location.

9. The method of claim 1, wherein the one or more user device parameters and the one or more network device parameters comprise a device model and a device label.

10. The method of claim 1, wherein comparing, for each candidate device identifier, the user device time stamp with the network time stamp associated with the candidate device identifier comprises:
generating a chronological sequence of candidate device identifiers based on the network time stamps; and
removing, from the chronological sequence, candidate device identifiers having the network time stamp that indicates a time that is before a time indicated by the user device time stamp.

11. The method of claim 10, selecting, based on the time stamp comparison, the target device identifier from the one or more candidate device identifiers comprises:
after removing candidate device identifiers from the chronological sequence, selecting a first device identifier in the chronological sequence as the target device identifier.

12. The method of claim 1, further comprising:
determining if the device identifier of the user device is associated with a high frequency band of the network or a low frequency band of the network; and
based on the determination, selecting the one or more candidate device identifiers that are associated with the high frequency band of the network or the low frequency band of the network, respectively.

13. The method of claim 1, wherein comparing, for each candidate device identifier, the user device time stamp with the network time stamp associated with the candidate device identifier comprises:
determining if a time gap between the user device time stamp and the network time stamp is above a threshold.

14. A computing system comprising:
a processor; and
a non-transitory computer-readable storage medium, having stored thereon program instructions that, upon execution by the processor, cause performance of a set of operations for updating a non-persistent device identifier associated with a user device at a media exposure measurement location, the user device having one or more user device parameters and a user device time stamp that characterize an activity of the user device on a network at the media exposure measurement location, the operations comprising:
obtaining network traffic data via the network, the network traffic data specifying, for each of a plurality of network devices communicatively coupled to the network at the media exposure measurement location, a network device identifier associated with the network device, one or more network device parameters associated with the network device, and a network time stamp that characterizes a time of at least one communication over the network by the network device;
comparing the one or more user device parameters to the one or more network device parameters associated with the plurality of network devices included in the network traffic data;
selecting, based on the parameter comparison, one or more candidate device identifiers from the device identifiers associated with the plurality of network devices and included in the network traffic data;
comparing, for each candidate device identifier, the user device time stamp with the network time stamp associated with the candidate device identifier;
selecting, based on the time stamp comparison, a target device identifier from the one or more candidate device identifiers; and
updating the non-persistent device identifier associated with the user device at the media exposure measurement location using the target device identifier selected from the one or more candidate device identifiers included in the network traffic data.

15. The system of claim 14, wherein:
the user device time stamp comprises a last-seen time stamp that characterizes a time when the non-persistent device identifier associated with the user device was last detected on the network, and
the network time stamp comprises a first-seen time stamp that characterizes a time when the network device identifier associated with the network device was first detected on the network.

16. The system of claim 14, wherein updating the non-persistent device identifier associated with the user device using the target device identifier selected from the one or more candidate device identifiers comprises:
replacing the non-persistent device identifier associated with the user device at the media exposure measurement location with the target device identifier.

17. The system of claim 14, wherein the non-persistent device identifier of the user device and the device identifiers of the plurality of network devices comprise a Media Access Control (MAC) address.

18. The system of claim 14, wherein the user device comprises a mobile phone.

19. The system of claim 14, wherein the network traffic data is collected by a streaming meter configured to monitor the network to collect the network traffic data, and wherein the streaming meter is communicatively coupled to the plurality of network devices via the network.

20. A non-transitory computer-readable storage medium, having stored thereon program instructions that, upon execution by a processor, cause performance of a set of operations for updating a non-persistent device identifier associated with a user device at a media exposure measurement location, the user device having one or more user device parameters and a user device time stamp that characterize an activity of the user device on a network at the media exposure measurement location, the operations comprising:
obtaining network traffic data via the network, the network traffic data specifying, for each of a plurality of network devices communicatively coupled to the network at the media exposure measurement location, a network device identifier associated with the network device, one or more network device parameters associated with the network device, and a network time stamp that characterizes a time of at least one communication over the network by the network device;
comparing the one or more user device parameters to the one or more network device parameters associated with the plurality of network devices and included in the network traffic data;
selecting, based on the parameter comparison, one or more candidate device identifiers from the device identifiers associated with the plurality of network devices included in the network traffic data;
comparing, for each candidate device identifier, the user device time stamp with the network time stamp associated with the candidate device identifier;
selecting, based on the time stamp comparison, a target device identifier from the one or more candidate device identifiers; and
updating the non-persistent device identifier associated with the user device at the media exposure measurement location using the target device identifier selected from the one or more candidate device identifiers included in the network traffic data.
